(19) United States
(12) Patent Application Publication
(10) Pub. No.: US 2003/0028621 A1
(43) Pub. Date: Feb. 6, 2003

(54) Presence, location and availability communication system and method

(75) Inventors: Patrick Shane Furlong, Parker, CO (US); Michelle Fawcett, Highlands Ranch, CO (US); Kevin J. Kershaw, Highlands Ranch, CO (US); Bradley Alan Schuler, Franktown, CO (US)

Correspondence Address: SWANSON & BRATSCHUN L.L.C., 1745 SHEA CENTER DRIVE, SUITE 330, HIGHLANDS RANCH, CO, 80129, US

(73) Assignee: Evolving Systems, Incorporated, Englewood, CO

(21) Appl. No.: 10/144,107

(22) Filed: May 13, 2002

Related U.S. Application Data
(60) Provisional application No. 60/293,146, filed on May 23, 2001.

(51) Int. Cl. G06F 15/16

(52) U.S. Cl. 709/219

(57) ABSTRACT

A system and method is disclosed for managing subscriber presence, location and availability (“PLA”) information across one or more communications networks. “Presence” requires both that a device be physically present within a network and that the device be in a state in which it can communicate. “Location” refers to the geographical coordinates associated with a communication device. “Availability” refers to a state characterizing whether a subscriber controlling a device desires to be contacted by another communicating entity. The presence, location and availability system (“PLAS”) provides interfaces between third party applications, third party suppliers of presence and location information, other PLA systems, subscribers and service provider administrators and enables subscribers to dictate and control access to subscriber presence, location and availability information. The PLAS makes presence, location and availability information available to third party applications in accordance with the subscriber defined preferences. In addition, the PLAS includes a database for managing subscriber identities, identity templates, permission lists, devices and their capabilities, device and capability templates, presence information, location information, subscriber dictated preferences and other information necessary for the PLAS to properly administer and control the flow of presence, location and availability information within and across networks.

### CROSS REFERENCE TO RELATED APPLICATION

This application claims priority from U.S. Provisional Application No. 60/293,146 and is related to co-pending and commonly-assigned U.S. Patent Application filed under Express Mail Label EV025902964US, entitled APPARATUS AND METHOD FOR EXTRACTING PRESENCE, LOCATION AND AVAILABILITY DATA FROM A COMMUNICATION DEVICE DEPLOYED IN A NETWORK, filed on even date herewith, both of which are incorporated herein by reference.

### TECHNICAL FIELD

The present invention is directed toward communication networks, and more particularly toward a system and method for providing subscriber presence, location and availability information across one or more networks.

### BACKGROUND ART

Communication service providers are locked in competition driving subscriber costs and service provider profits down. Critical for service provider increase in profits is providing enhanced service options for subscribers. These value added service options will help distinguish service providers while increasing revenue from subscribers.

One area service providers are beginning to exploit is presence and availability based services. These services allow a subscriber to dictate availability preferences based upon his or her presence within a service provider's network and availability criteria such as day of the week and time of day. Additional opportunities exist to help subscribers manage communications among a variety of communication devices they are likely to use. For example, it is not unusual for subscribers to use personal computers to exchange electronic mail and instant messaging and wire line and wireless phones to transmit voice and data. The increasing proliferation of devices and methods of communication makes it highly desirable for a subscriber to be able to manage all simultaneously through a single interface. In addition, subscribers have an increasing need to guard and control their privacy.

Recognizing a need for uniformity, members of the voice, data and wireless networking, services and applications community formed the Presence and Availability Management (“PAM”) Forum to develop uniform Application Program Interfaces (“API”) across various telephony and Internet Protocol (“IP”) technologies for sharing presence and availability information. While the PAM Forum is helpful in defining what information, and in what form, should be able to flow across disparate networks featuring disparate communication devices, the Forum does not specify how to build network systems utilizing presence and availability information. In addition, the PAM Forum has not addressed the desirability of incorporating location information into a communication network to further enhance application offerings and subscriber control.

The present invention is intended to overcome one or more of the problems discussed above.

### SUMMARY OF THE INVENTION

A presence, location and availability system (“PLA system”) features a presence location and availability server (“PLAS”) for managing a subscriber's location, presence and subscriber-designated availability options across potentially disparate networks with potentially disparate devices. As used herein, “presence” is the existence of a communications device within the network through which an entity can communicate. Presence requires both that a device be physically present within a network and that the device be in a state in which it can communicate. Presence also typically implies the physical presence of a subscriber of the device. “Location” refers to the geographical coordinates associated with a communication device. Location may, if the context so implies, also mean a digital representation of the geographical location of a device. “Availability” refers to a state characterizing whether a subscriber controlling a device desires to be contacted by another communicating entity.

The PLAS provides interfaces between third party applications, third party suppliers of presence and location information, other PLA systems, subscribers and service provider administrators. The PLAS enables subscribers to dictate and control access to subscriber presence, location and availability information. Third party application providers may develop a wide variety of applications using such information which service providers can offer to subscribers. Subscribers may enter identifying information about themselves, their communication devices and the capabilities of their communication devices. Subscribers may further specify their availability within the network based on criteria including presence, location, time of day and day of the week. The PLAS makes presence, location and availability information available to third party applications in accordance with the subscriber defined preferences. In addition, the PLAS includes a database for managing subscriber identities, identity templates, permission lists, devices and their capabilities, device and capability templates, presence information, location information, subscriber dictated preferences and other information necessary for the PLAS to properly administer and control the flow of presence, location and availability information within and across networks.

By providing published, public APIs, developers of third party applications are encouraged to develop value added services based on the presence, location and availability information provided by the PLAS. The public APIs free third party application developers,from having to use a technology-specific adapter for each type of device or capability that may be used by a subscriber, thereby lowering development costs. The PLAS also makes possible time, location, and availability event-based applications for targeting interested subscribers.

Service providers and subscribers benefit by competition in the development of useful third party applications. Subscribers further benefit by being able to control their presence and location information and structure their availability in a manner suiting their individual needs at any given point in time or location. Subscribers also benefit by being able to manage this control from a single point across disparate networks.

Service providers also benefit by being able to offer value added services to subscribers and thereby differentiating their service offerings from other service providers as well as by providing an avenue for increased revenue. Service providers may draw revenue from basic subscriber fees and from requests to access or modify presence information, reflected in usage records produced by the PLAS. The PLAS allows service providers to manage presence, location and availability across different service types, different networks and different service providers.

Some of the services that service providers may offer include location driven content (i.e. coupons and ads for local stores), traffic updates, stock alerts, news reports and weather reports. Availability of the PLA information using standardized interfaces no doubt will prompt developers of third party applications to develop many more useful and imaginative services.

### BRIEF DESCRIPTION OF THE DRAWINGS

FIG. 1 is a schematic representation of a PLA system residing within a communications networks infrastructure;

FIG. 2 is a schematic representation of a PLAS within a PLA system;

FIG. 3 is a flowchart illustrating a subscriber sign-up procedure;

FIG. 4 is a flowchart illustrating an event registration procedure; and

FIG. 5 is a flowchart illustrating a third party message request procedure.

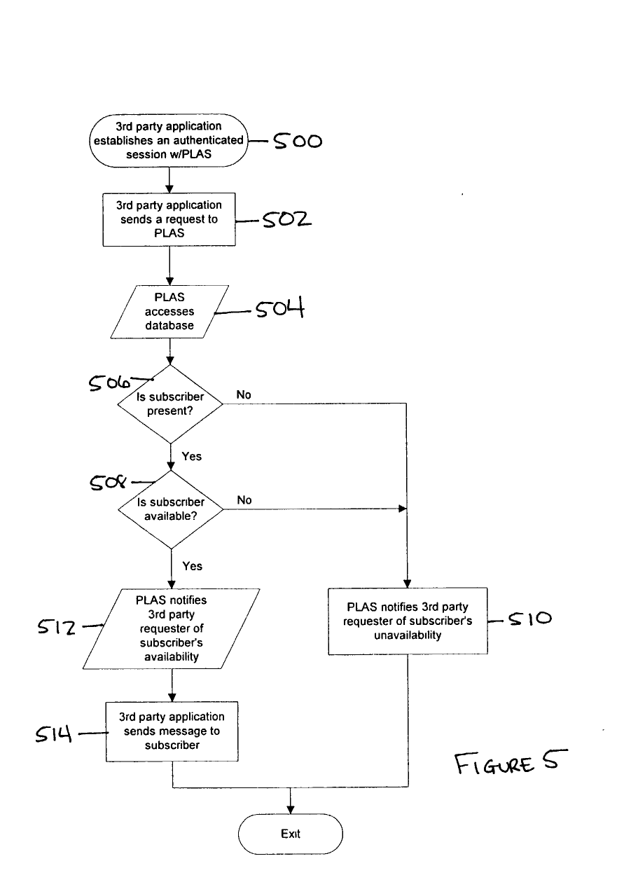

### DETAILED DESCRIPTION OF THE PREFERRED EMBODIMENT

Overview

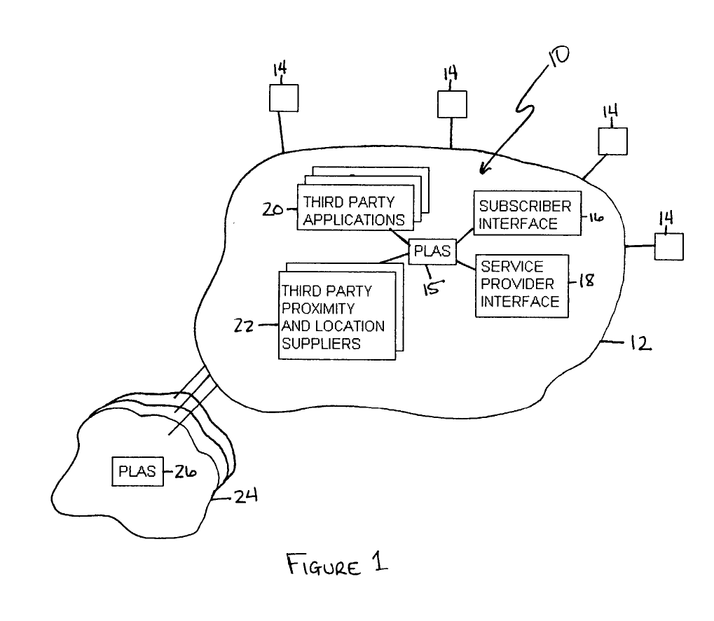

FIG. 1 schematically illustrates an overlay of the PLA system 10 on a service provider's communication network 12. The communication network 12 may be, by way of example, a voice network, a data network, a wireless network or any combination thereof for transmitting telephonic or data signals. The network 12 includes a variety of subscriber communication devices 14 which may include, by way of example, conventional telephones, cellular phones, wireless application protocol (“WAP”) phones, personal computers and personal management (“PDA”) devices.

As illustrated in FIG. 1, the PLA system 10 is created around a presence, location and availability server (“PLAS”) 15. In its full implementation, the PLA system includes a subscriber interface 16 including a graphical user interface (“GUI”). The subscriber interface may be remotely accessed by personal computers or the like. A service provider interface 18 is also provided in communication with PLAS 15 by means of a GUI or the like for allowing service provider control of the PLAS 15. The PLA system 10 further includes any number of third party applications 20 which utilize proximity, location and availability information about a subscriber associated with the network 12. The PLAS 15 includes interfaces with these third party applications. Finally, the PLA system 10 includes third party proximity and, preferably, location suppliers 22 with the PLAS 15 including interfaces therewith. As indicated, other communication networks 24 may interface with the network 12 and each of these communication networks 24 may include a PLA system 26 similar to the PLA system 10 described above. By virtue of such a multi-network interface, proximity, location and availability information about subscribers in the different communication networks 12, 24 can be shared.

In operation, the PLAS 15 keeps track subscribers'presence and availability in the network (including, optionally, their geographic location) and processes third party requests for information.

System Architecture

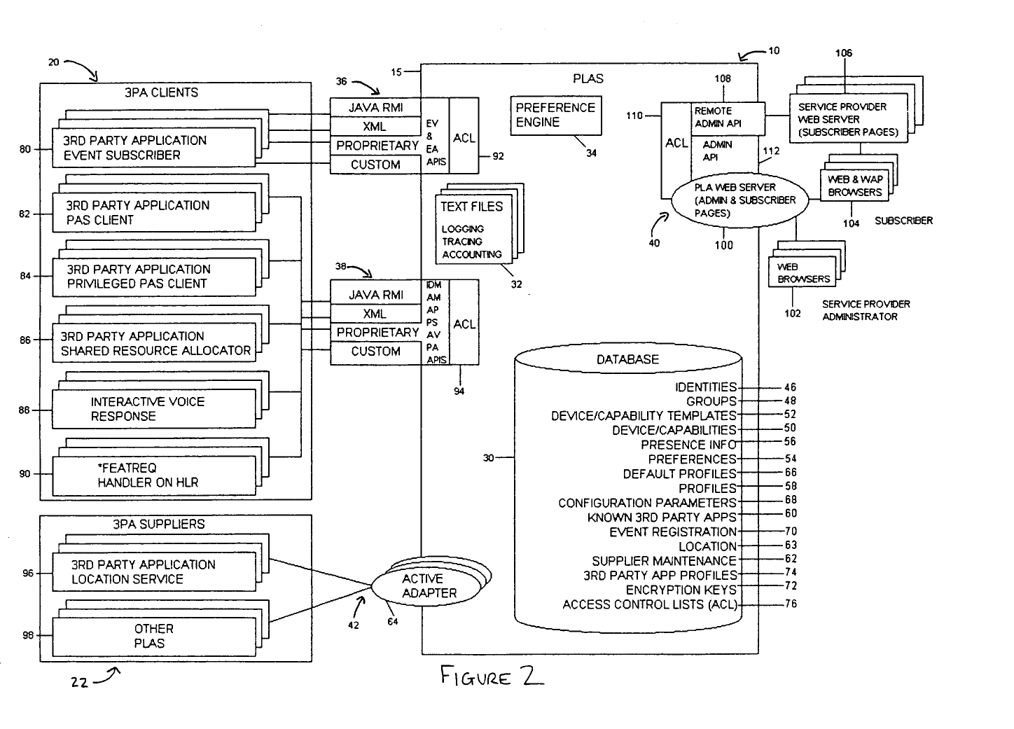

FIG. 2 illustrates the PLA system 10 introduced in FIG. 1 in greater detail. The heart of the PLA system 10 is the PLAS 15. The PLAS 15 includes a database 30 for managing and storing a number of functional attributes and other data in tables to be discussed in greater detail below. In the present preferred embodiment the database is a relational database, but other databases such as object-oriented databases may be suitable as well. Text files 32 are also part of the PLAS 15 to record static, historical information. The PLAS 15 also includes a set of text files 32 for logging, tracking and accounting purposes. For example, each time PLAS services are invoked, accounting records are constructed identifying the subscriber, the type of service invoked and any associated third party application and the records are stored in the text files 32. Such accounting occurs regardless of whether the PLAS 15 was accessed directly through a web interface or by a third party application provider. Logging and tracing permit analysis of behavior or anomalies while accounting records allow the service provider to generate revenues based on PLAS usage.

A preference engine 34 serves as the central processor for the PLAS 15 and facilitates processing of preference rules established by the service provider and the subscriber which are stored in the database 30 to control access to the proximity, location and availability criteria of each subscriber by third party applications 20. These preferences govern access to information on the presence, location and availability of each subscriber. Criteria which the preference engine uses when processing these rules include, but are not limited to, recipient identity, recipient location, time of day, day of the week, requester/sender identity, types of communication, the presence of communication devices and their capabilities.

The PLAS 15 is preferably be deployed on Unix-based information systems. One exemplary platform may be a Sun Netra T1405 with two Ultra Sparc II processors. The base operating system for the PLAS 15 may be Solaris 7. A relational database is preferably used as the database 30 to provide data for system. Oracle relational database management system is one suitable relational database.

Also part of the PLAS 15 are interfaces with third party applications, including a third party application event subscriber interface 36, a standard third party application interface 38 and a web-based administrator/subscriber interface 40. An interface 42 is also provided for third party suppliers of presence and location information about subscribers. Sun Java RMI is one example of a supported technology for third party access to the PLAS 15.

The PLAS database 30 stores the information which supports the PLAS functionality. An identity record table 46 maintained by the PLAS database includes the identities of subscribers in the form of a unique digital representation of each subscriber. The identity may also include aliases by which a subscriber is known in certain third party applications. Typically an identity is added to the PLAS by associating a subscriber with a unique digital identity and is initially entered when a subscriber signs up for the PLA system service. The addition of new identities or changes to identities can be effected through the administrator/subscriber interface 40 either by third-party applications or a service provider administrator.

Group identities records 48 are collections of identities selected by a subscriber or third party application for a common purpose. Group identities are useful in the PLAS 15 because they support the creation of chat groups or buddy lists and they allow the subscriber to state availability preferences in terms of those groups. For example, a group may consist of the immediate family of a subscriber or the co-workers of a subscriber. Groups may also be combined to form larger groups. Groups may be created and altered by the subscriber through the administrator/subscriber interface 40. Optionally, third party applications may also be able to control group identities.

Another feature of the database is a device or agent profile table 50. Each subscriber device 14 used with the PLAS 15 is assigned a unique digital identification. A single device may be associated with one or more subscribers. For example, an office telephone may be associated with several employees of the office who are subscribers to a PLA service. The device identifier allows a subscriber to assign preferences with respect to communications that use that device. It is possible for a single device to support more than one communication method, and as a result a device may have multiple capabilities assigned to it. In support of multi-capability devices, the PLAS 15 maintains records containing device and capability templates 52. For example, a single communication device may operate with several modes of communication (e.g., e-mail, instant message, voice, etc.). In order to facilitate subscriber convenience, device templates present the subscriber with a pre-configured set of communication capabilities and profile information, appropriate for the particular device used. The service provider administrator may then use that template to define a set of default modes for a particular communication device and modify those defaults to fit the subscriber's needs. For example, a device template for a particular device may provide more communication modes than a subscriber has elected to enable. Thus, a subscriber with a WAP phone may only wish to associate the voice feature with the PLA system. The service provider administrator may modify or strike functions or features defined in the template as that information is stored in the record representing the subscriber's access.

Among the most important information managed by the database 30 are contained in the preferences table 54 of the subscribers. The PLAS 15 controls access to a subscriber by applying availability rules in the preference engine 34 when an access request for that subscriber is received. Subscribers are able to establish availability rules by stating preferences which are lists of who can and cannot have access to the subscriber based upon several criteria, such as the identity of the requester, the requester's location, the time of day, the type of communication and the device. Regardless of subscriber activity, preferences come into play at virtually all times. Furthermore, a default preference is always available for use in processing access requests if no explicit preference has been entered; the default preference will indicate whether access is to be allowed to any party requesting it. Once preferences are indicated, all communications that are not on the preference list will be barred. In order to evaluate availability, the following criteria are to be provided:

a) Who is attempting to make a contact. Subscribers may elect to allow/deny access by certain third party applications or individuals to contact the subscriber.

b) What type of communication is requested. Subscribers may elect to allow/deny access to specific devices or a capability of a select device.

c) When is the subscriber available (by day of the week and time of day). For example, co-workers can only reach a subscriber between 9 am -5 pm.

d) Where is the subscriber available. For a geographically enabled PLAS, stored preferences could include receipt of information when the subscriber arrives within or departs a select geographic location.

e) What mode the subscriber has activated. Subscribers may customize modes; for example a “travelling” mode, a “office” mode or a “weekend” mode, to name but a few possibilities.

A subscriber's preferences may include several concurrent criteria, e.g., time of day and type of communication received. Preferences would typically be controlled by a subscriber over the web accessible GUI interface 40 using an appropriate web browser. In limited instances third party applications may be able to vary preferences.

A presence information records table 56 contain continuously updated information about a subscriber's presence in the service provider's network. Presence as used herein is the existence of a device within the network; whether or not a device will receive a particular communication (its availability) is a function of the specified preferences set forth in the preference records 54.

A profile records table 58 maintain information required by the service provider or third-party applications to be associated with each subscriber that is necessary for the management of that subscriber's identity in the context of the third-party application or the service provider's business. Key information for the service provider is carried in a profile known as the Subscriber Information Profile (“SIP”) which, in a preferred embodiment, is mandatory for identities of subscribers utilizing the PLA service. Examples of information carried in the SIP might include customer name, address, linkages to customer care, billing or other designated systems in the service provider's network. Use of an SIP template provides a set of default information to be provided by each subscriber added to a PLA system.

The known third party applications record table 60 contains a record of third party applications which have been accepted for use by the service provider in its PLA system. The third party applications use the availability information provided by the PLA system to provide presence-enabled subscriber services. Select presence, location and availability information may be provided to the third party applications so that the subscriber may enjoy these services. In order to ensure subscriber privacy, third party applications operate under selected authorizations controlled through access control lists 76 (discussed below) that define acceptable interactions with a subscriber's PLAS information.

In some instances, third party applications will be event subscribers. As will be discussed further below, an event subscriber application is one which relies upon the PLAS 15 to be notified upon the happening of a select event. An example of such a notification might occur when a subscriber enters a designated geographic area. Records in a supplier maintenance table 62 define the attributes of third party suppliers of location and presence information necessary for the PLAS 15 to receive and process information from those suppliers. The supplier maintenance record table 62 is accessed by an active adapter 64 to control data requests from the PLAS to location and presence information suppliers. This active adapter will be described in greater detail below.

A location records table 63 contains subscriber location data from third party suppliers for use in processing availability requests from third party applications.

A default profile records table 66, as the name suggests, contains default profiles for select subscribers and third party applications. For example, the default profile could contain the SIP information required of all new subscribers.

A configuration parameters table 68 contains information used to set basic operational characteristics of the PLAS 15 such as communication socket identifiers and log file names.

An event registration records table 70 contains the list of events and associated information for which event subscriber applications have subscribed. Each third party event subscriber application will include an event handler which is registered with the service provider and stored in the event registration record. The event handler is invoked by the PLAS 15 when an appropriate event has occurred and the event parameters match the selected subscription criteria. Representative events to be included in the event handler may include the following:

a) A subscriber enters/exits a specific location (i.e., shopping mall, work, home).

b) A subscriber's third party application profile 58 is modified.

c) A subscriber's third party profile 58 changes from the default profile.

d) A group 48 gains/loses a member.

e) A subscriber becomes available/unavailable to a select third party application or other subscriber for a given type of communication.

f) A device for a given communication type becomes present/unavailable for a subscriber.

g) A subscriber gains/loses a new communication capability on a device.

h) A subscriber switches from one preference to another.

i) A subscriber's preferences are modified.

As currently contemplated, the PLAS 15 system will include a specification and/or an event handler template. Third party applications should conform to this specification or be supported through an appropriate custom adapter. As an example, a third party application provides a subscriber with notification of sales and coupons as the subscriber enters a shopping mall. This application will authenticate with the PLAS 15, register an event handler and subscribe for an event notification whenever any subscriber that is previously signed up for a service enters the specific geographic location encompassing the shopping mall.

An encryption key records table 72 contains keys for encrypted data. For example, data regarding the location of a particular subscriber or device may be encrypted to ensure the subscriber's security.

The subscribers or groups of subscribers to the PLA system 10 may have associated profiles of information which carry attributes used in the management of their communications and presence information for third party applications. These attributes are carried in third party application profiles 74 specific to each third party application. The third party application profiles 74 carry information necessary for the third party applications to manage its interactions with the subscribers, their communication devices and the presence, location and availability information. Third party application profiles 74 may include a profile template identifying default information for the third party application profile. The third party application profiles 74 may be modified by subscribers, third party application providers or PLAS administrators as dictated by the service provider.

An access control list records table 76 contains information on who is authorized to access PLAS information, modify data stored in the database, or otherwise administer the PLAS 15. Access control lists are critical to PLAS security and are modified by service provider administrators.

Third Party Applications

The PLAS 15 system provides value and utility to subscribers through applications which will typically be provided by third parties and will be known herein, for ease of reference, as third party applications. Several classes of third party applications are envisioned for use with the PLAS system 15. Event subscriber applications 80 register with the PLAS 15 to be notified when certain types of events occur for a specific set of subscribers of interest. Information about the event subscriptions is maintained in the event registration records table 70. One preferred set of application program interfaces (“API”) available to the event subscriber application is specified by the PAM Forum Specification Document and may be augmented with proprietary APIs of the PLAS supplier. Applications written to the PAM Specification would preferably inter-operate with the PLAS 15. The PAM Specification Document Version: 0.9 dated Nov. 27, 2000 and subsequent revisions are available on the PAM Forum website at www.pamforum.org/learn_more/PAM_spec_{—}09.pdf and are incorporated herein by reference.

A second class of third party applications are PLA client applications 82. This class of applications would have limited access to non-privileged PLA information or non-privileged information regarding actions of the PLAS 15. Some examples of third party application clients with this level of access might be traffic or weather reporting services and simple instant messaging services.

The next class of third party applications are privileged third party application clients 84. Privileged third party applications are those authorized to use a larger set of APIs to interact with the PLAS 15 and its information records to provide enhanced features to subscribers. Each privileged third party application provider has a unique set of permissions specified in the access control list 76 which dictate the scope of access to information and actions granted by the PLAS 15. Some examples of representative privileged PLA clients might include value added instant messaging services which have agreements with a service provider and require control over profile data or group membership, content or service partners associated with a service provider, and service provider control applications.

Another next class of third party application clients are shared resource allocators 86. A shared resource allocator is responsible for allocating a shared communication device with an individual person. One example might be a “loaner” office or a “hot desk” with a telephone and a computer which are dynamically assigned to a user as a sensor recognizes the person in the office. These types of applications require access to a certain set of the API as well as a specified subset of communication devices associated with the PLAS 15.

Still another class of third party clients might be an interactive voice response application 88. This application would be used by subscribers to switch between preferences by calling into a voice automated system to choose the set of preferences to be activated.

Yet another class of third party applications is a feature request handler (*FEATREQ Handler) 90 residing on a Home Location Register (“HLR”). The HLR can provide a facility which allows a subscriber to dial a set of numbers prefixed with the star key on a wireless phone to trigger a preprogrammed action. A small set of numbers may be assigned for the purpose of switching the subscriber's active preferences. For example, *721 might select a first set of preferences that the subscriber has configured, while *722 switches to a second set of preferences. This feature allows a subscriber to quickly and easily change among preferences.

Security for the third party application interfaces 36 is provided by an access control layer (“ACL”) 92 which governs the capabilities granted to each third party application 80 using the access interface 36. The access control layer 92 limits the operations of third party applications based on the information retained in an ACL records table 76.

Communication between third party applications 20 and the PLAS 15 may be enabled through any of several technologies. Supported platforms for third party communication with the PLAS 15 could include Java Remote Method Invocation (“RMI”) which may occur over a standard socket without encryption or over secured sockets layered with encryption. Encryption keys are established with a public/private key exchange that occurs while configuring each third party's access to the PLAS 15. Another option for communication is extensible markup language (“XML”). XML has the advantage of facilitating and transporting data between disparate architectures while maintaining the context of the data. It is also contemplated that a PLAS developer may provide proprietary APIs which eliminates the need for translation of data from one format to another. Yet another option is custom interfaces developed by the third party application providers. Such interfaces utilize the same APIs and ACLs to communicate with the PLAS as the other technology adapters, but have a “front end” custom built for each specific application.

For event subscriber third party applications 80, the PLAS interface 36 would preferably utilize an interface supporting event subscription (“EV”) and application notification (“EA”) APIs. The PAM Specification document referenced above specifies the nature of these APIs. Of course proprietary APIs could perform the same function.

For standard third party application interfaces 38, the PLAS 15 supports the same communications platforms as the third party application event subscriber interface 36. The APIs for this interface preferably include identity management (although the abbreviation “IM” is used in the PAM specification, “IDM” is used herein and in the FIGs. to avoid confusion with the abbreviation for “instant messaging” discussed below), agent management (“AM”), agent provisioning (“AP”), presence (“PS”), availability (“AV”), profile access (“PA”). These interfaces are also specified in the PAM Specification Document, although proprietary APIs could perform the same function.

In addition, the PLAS 15 may provide for a location API which is not specified in the PAM specification. Other facilities beyond those called for by the PAM Specification Document may also be included. Each invocation of an API is filtered through access control layer 94 in order to guard access to sensitive information, protect the integrity of the PLAS 15 and restrict the level of access that each client is offered in accordance with the appropriate access control list record 76.

In order for the PLAS 15 to function, it should be able to determine and provide presence and location information to the various third party applications. In addition, the PLAS 15 should be able to communicate with PLA systems on other networks. In FIG. 2, third party application location and presence suppliers are indicated at 96 and other PLAS servers are indicated at 98. A location service 96 is an application which provides geographic location information to the PLAS 15 for a set of subscribers. It is expected that each location service 96 will be characterized by whether it provides a PAM compliant interface and further, whether location information is pushed out by, or pulled in from, these applications. Those services which are PAM compliant initiate connections to the PLAS 15 and begin sending information using the same set of adapters and APIs as privileged clients 84 and are treated by the PLAS 15 as such. Location services which are not PAM compliant but which depend upon the PLAS to initiate the connection, or which expect the PLAS 15 to periodically pull information are connected to the PLAS 15 through an active adapter 64. One form of an active adapter, specifically a Network Adapter, is described in the above referenced co-pending patent application..

Presence services will interface with the PLAS 15 in the same manner described above with respect to the location service applications.

The other PLASs 98 help provide a complete and robust implementation of the PLA system which can communicate with other PLA systems of other service providers. This will facilitate the management of preferences of subscribers using different network providers. The respective PLA systems need to communicate with each other in order to facilitate subscriber control over communications with subscribers who use different service providers. Connection of these other PLA systems 98 to the PLAS 15 may require use of an active adapter 64.

The active adapters 64 are applications residing either on the PLAS 15 or elsewhere which communicate with third party applications 22 that supply location or presence information to the PLAS 15. Active adapters 64 also control communications with other PLA systems. Each active adapter 64 is responsible for initiating or accepting a connection to the outside application, using that application's API to exploit its services and transferring the information to the PLAS through the PLAS APIs. Typically, different active adapters may need be employed for each third party supplier with which the PLAS 15 must communicates. The active adapter 64 serves a gateway function, operating in one role as a client or server to the third party location supplier applications and in a second role as a PAM-compliant third party application using the standard PLAS APIs. At PLAS initialization, the active agents attempt to establish contact with their supplier services using appropriate authentication methods for that supplier. In some instances there will be sophisticated authentication exchanges dictated by the third party location supplier applications. In other instances, there may be virtually no authentication procedure as in the case where the supplier is directly connected to the PLAS 15 with no intervening network. Regardless of the circumstance, the active adapter 64 establishes the needed level of connectivity to the supplier.

With respect to establishing a third party supplier connection the PLAS APIs, because the active adapter 64 is normally co-resident on the PLA hardware platform, only minimal authentication would be required. Irrespective of the extent of authentication, once the process is complete, the active adapter 64 requests the handles (interface identities) which are available to the distinct PLAS services. The PLAS 15, on receipt of a request, uses the authenticated identity of the active adapter to determine, through ACL 94, which of the PLAS interfaces the active adapter is authorized to use on behalf of the third party location supplier 96 it represents. The PLAS 15 builds a list of the authorized interface handles and sends the list to the active adapter 64 for use in ongoing communication with the PLASs.

The third party application event subscriber interface 36 and standard third party application subscriber interface 38 use the same methods to authenticate the third party applications attempting to contact the PLAS. This process of authentication of client identification is critical first for gaining access to the PLAS services and second for establishing which PLAS services the particular client is authorized to use.

Third Party Activity

Clients (i.e., third party application event subscribers and third party applications) wishing to communicate with the PLAS 15 begin by establishing network level contact. Such contact may be through a URL or other standard means. Next, the client and the PLAS 15 identify their respective authentication interfaces. These interfaces are identified through handles exchanged at the start of the authentication process. The PLAS 15 should preferably support more than one authentication method. The PLAS 15 chooses its preferred authentication method from the list presented by the client and responds with that method to the clients authentication interface. If the client list does not contain a method supported by the PLAS 15, the PLAS 15 responds to the request indicating that none of the offered methods is supported.

Once an authentication method is chosen, the PLAS 15 and the third party application challenge and authenticate each other using the selected authentication method. Once the authentication exchange is completed, the client will request the handles which are available PLAS services. The PLAS 15, upon receipt of such a request, uses the authenticated identification of the client to determine, through the access control lists 76 and the access control layers 92, 94 which of the PLAS interfaces this client is authorized to use. The PLAS 15 builds a list of these interface handles and returns it to the client for use in ongoing communications with the PLAS 15. The client can abort the authentication process with the PLAS 15 by making an appropriate request. Encryption is employed during the authentication challenge interface between the client and the PLAS 15.

The service provider/subscriber interface 40 provides a web-based interface for subscribers and service provider administrators to control data input and preferences. This interface may be served by a web server 100 hosted by the PLAS 15 for facilitating both service provider administrator and subscriber access to the PLAS 15. Alternatively, the service provider may choose to develop its own administrative interfaces and host them on its own web server 106. The web server 100 includes the ability to provide secure, encrypted access for web browser based clients and uses industry standards to facilitate authentication and password protected access control. The web server 100 supports its clients using hypertext markup language (“HTML”) served through Java Server pages. The web server 100 communicates with the PLAS 15 through the Java RMI-based PLAS APIs. Web browser-based clients communicate with the PLAS 15 through the web server to access interface information and configure and control the PLAS 15. HTML based pages are offered for service provider administrators. Both HTML and wireless markup language (“WML”) based pages may be offered for subscribers. A web browser 102 supports a suitable graphical user interface for the service provider personnel.

Subscriber Access

Subscribers may access the PLAS 15 either through the PLA web server 100 via graphical user interfaces supported by web and WAP browsers or via the service provider web server 106. Apache web server is suitable to provide these interfaces; Rogue Wave Objects may be incorporated for development efficiencies and system performance (Rogue Wave Tools.h++ and Rogue Wave Threads.h++ are representative objects). Remote administration APIs, 108 includes command, control and configuration capabilities specific to the PLAS 15. An access control layer 110 filters each invocation of a remote administrative API to guard access to sensitive information, protect the integrity of the PLAS 15 and restrict the level of access that each subscriber is provided. In a like manner, the administrative API 112 includes command, control and configuration capabilities and works in conjunction with the access control layer 110 to guard access to sensitive information, protect the integrity of the PLAS 15 and restrict access to authorized service provider administrators.

A simplified example illustrates the operation of the PLAS access control level and the preference engine 34. A service administrator receives a request for access to the PLAS 15 from a presence-aware instant messaging (IM) service. The administrator adds this messaging service to the list of supported third party applications, sets the initial password and configures its access control list. The access control list gives the IM application authority to register for the PHONE-ON notification and to create device profiles defining devices it supports.

The providers of the IM application establish connectivity and begin client services. As the IM application initializes, it connects to the PLAS 15 providing authentication credentials. Following authentication, the IM application registers the interface and events for which it wishes the PLAS 15 to provide notification. Of these, only the request for PHONE-ON notification is accepted. The IM application subsequently attempts to define a subscriber profile. This attempt is rebuffed by the PLAS 15 as the application has not been given authorization through the ACL to perform such an operation.

Alternatively, the IM application receives a request from a user of instant message services to send an instant message to the subscriber. The IM application queries the PLAS 15 for availability of instant messaging from the requester to the subscriber. The preference engine 34 analyzes the rules defined in the preference records 54 and determines that the subscriber is available via his WAP phone. The subscriber's WAP phone address is provided to the IM application and the IM application forwards the instant message to the subscriber. For security reasons, under most circumstances third party applications will only be advised of subscriber availability, while location and presence information will remain inaccessible.

### EXAMPLES

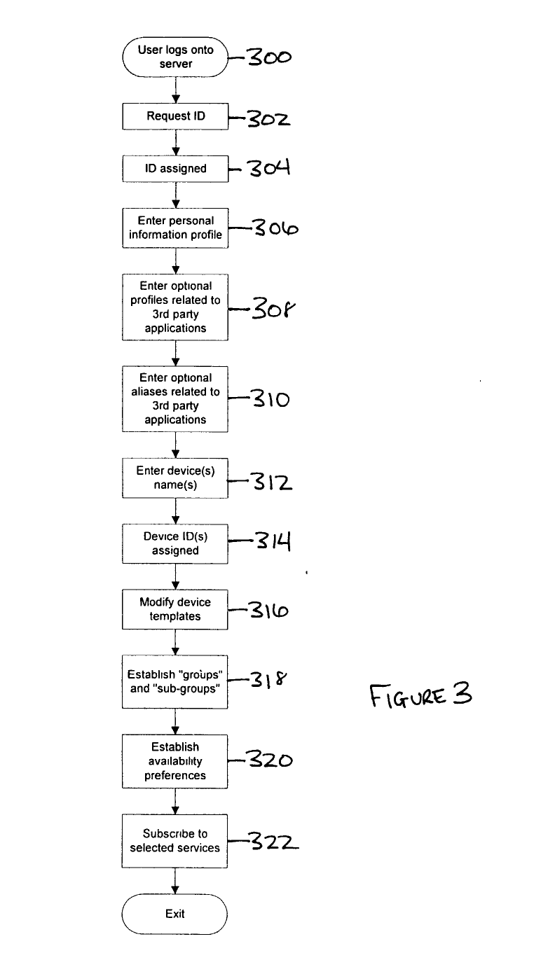

Referring to the flowchart of FIG. 3, assume that an individual has multiple communication devices 14 and subscribes to various services and third party applications 20 which use the services offered by the PLA system 10. Moreover, the individual (hereinafter, the “subscriber”) would like to centralize the management of the devices and services.

The subscriber logs on the server 15 through the web interface 104 (step 300) and requests a subscriber ID (step 302) allowing the use of the PLA system 10 services. An administrator for the service provider generates an ID (step 304) which is stored in the identity record 46 of the database 30. Once the account and password have been established, the subscriber may enter information for the personal profile (step 306).

The subscriber then establishes optional profiles related to particular third party applications (step 308) as well as defines his optional aliases (step 310); this information is stored in the profiles and identities records 58 and 46.

The subscriber then selects devices to use (step 312), which are assigned device IDs (step 314). Based on device templates 52, information about the devices and the capabilities which are to be enabled is supplied (step 316) and stored in the device capabilities record 50 of the database 30.

If desired, the subscriber may establish groups and sub-groups of individuals with common interests or common access to the subscriber (step 318). And, importantly, the subscriber establishes availability preferences (step 320) denoting an ability and willingness to communicate with other individuals; such preferences, which may be modified by the subscriber at any time, are entered into the preferences record 54 of the database 30. For each preference item, the subscriber may specify a geographic location or area in which the subscriber is “available”, a time or range of times during which the subscriber is “available”, a device or number of devices having specified capabilities which are to be enable, and designated people, groups or services which may have access to the subscriber.

The subscriber may also subscribe to some selected applications (step 322) which are available from his service provider. For example, a third party service that provides traffic condition notifications to subscribers is an example of a non-privileged third party client 82; a service that notifies the subscriber of a nearby “buddy list” members is an example of privileged third party client 84; and a service that sends electronic “coupons” to the subscriber when the subscriber approaches a specified shopping all complex is an example of a third party event subscriber application 80.

The resulting preference items may be considered a multi-dimensional matrix stored in the preferences table 54 resembling the following exemplary subscriber record:

| Preference Title | WORK | |
|---|---|---|
| Location | n/a | n/a |
| Active when | Mon.-Fri. | 9 am-5 pm |
| Services | Instant Messages | Voice Calls |
| Available | Co-workers, Family | Co-workers, Family |
| Not Available | Bob, James, Traffic Service, | Kim |
| | Buddy Near, Mall Coupons, | |
| | Friends, Everybody Else | |
| Preference Title | HOME | |
| Location | within 100 feet of home | |
| | address | |
| Active when | n/a | n/a |
| Services | Instant Messages | Voice Calls |
| Available | Bob, Family, Friends, Boss | Family, Friends, Boss |
| Not Available | Co-workers, Traffic Service, | Jason |
| | Buddy Near, Park Field | |
| | Coupons, Everybody Else | |
| Preference Title | MALL | |
| Location | within 100 feet of mall | |
| Active when | n/a | n/a |
| Services | Instant Messages | Voice Calls |
| Available | Bob, Family, Friends, Boss, | Family, Friends, Boss |
| | Mall Coupons, Buddy Near | |
| Not Available | Co-workers, Traffic Service, | Jason |
| | Everybody Else | |
| Preference Title | TRAVEL | |
| Location | n/a | n/a |
| Active when | Specifically enabled | |
| Services | Instant Messages | Voice Calls |
| Available | All | All, Everybody Else |
| Not Available | Charlie, Mall Coupons, | Chris |
| | Buddy Near | |

Once the subscriber has completed the sign-up procedure of FIG. 3, turning on a device, such as a cell phone or a wireless PDA, enables a third party location service 96 to acquire location information and convey the information to the PLAS 15 to be processed by the preference engine 34 and stored in the appropriate table in the database 30. Such information is updated by the third party location service 96, thereby allowing the PLAS 15 to maintain current presence and location information about the subscriber.

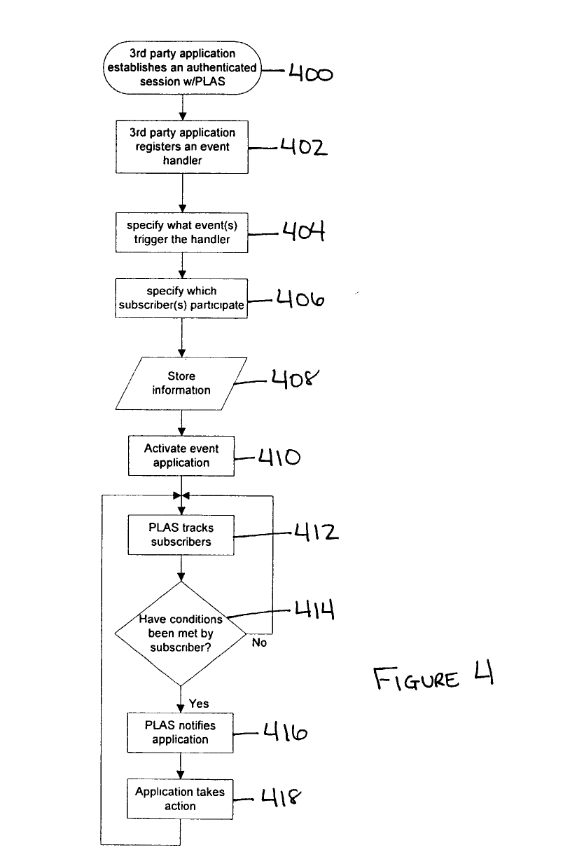

Third party events applications 80 were previously described. Referring to FIG. 4, in operation a third party application establishes an authenticated session with the PLAS 15 (step 400) and then registers an event handler (step 402). To do so, the application must specify what event(s) will trigger the handler (such as a subscriber entering into specified geographic area) (step 404) and which subscribers will participate (step 406). The information is received by the PLAS 15 and stored in the event registration table 70 of the database 30 (step 408). After the event is registered and the application activated (step 410), the PLAS 15 tracks subscribers (step 412) through the third party location service 96. When the status of a subscriber's device changes (such as by entering a geographic area), the preference engine 54 compares the status with the conditions specified by the third party event application and stored in the database 30 (step 414). If the conditions are met, the PLAS 15 notifies the third party event application (step 416) which takes the appropriate action (such as sending the subscriber coupons or advising the subscriber of traffic conditions in the area) (step 418).

If a third party application wants to send a particular subscriber a message, it first establishes an authenticated session with the PLAS 15 (step 500) and sends a request to the PLAS 15 (Step 502). The preference engine 34 accesses the appropriate tables in the database 30 (step 504) to determine if the subscriber is present (step 506) and available (step 508). If neither condition is met, the PLAS 15 notifies the requesting application of the subscriber's unavailability (step 510). If, however, the subscriber is both present and available, the PLAS 15 notifies the requesting application of the subscriber's availability (step 512) and the application sends the message to the subscriber (step 514).

The following is an example of the practical application of the PLAS 15. A subscriber, John, leaves home for work. He wants to be notified of traffic conditions on the interstate and enables his “Traveling” preference using the via voice recognition (“IVR”) from his wireless phone. He receives an alert about an accident from the traffic agency (a third party application provider) over his WAP phone and changes his route to avoid the congestion.

John's work preferences activate at 9:00 AM based on the designated time preferences when he disables the “Traveling” preference. At work, John's presence and availability is by the PLAS 15 and he receives an instant message from a co-worker (part of his designated “co-worker” group) for his approval. While in a team meeting, his wife (a member of John's “family” group) sends an instant message. The preference engine 34 processes the availability of John in accordance with his preference 54 and the message is delivered to John's WAP phone. Others trying to reach John will be unsuccessful if not part of a group from which John will accept messages..

At the end of his work day, John leaves work and, as he arrives in his designated “Home” area, his availability rules change to reflect the new location.

On a Saturday, John goes to the mall to pick up a birthday present for his wife. As he approaches the mall, the Mall Coupons application (a third party event application) activates. The Mall Coupon service is informed that John is entering the mall's geographic area and the service sends him an electronic coupon for the jewelry store in the mall. This message is delivered to John's WAP phone based on the preference rules. While shopping, the “Buddy Near” proximity service (still another third party application) determines that John's friend Bob is in the same mall and sends a message to John's WAP phone informing him that Bob is nearby and a message to Bob informing him that John is nearby. The application then sends both individuals a link to a private Buddy Near chat room. Bob and John communicate in the chat room suggested by the notification and arrange to meet.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims.

What is claimed is:

1. A presence, location and availability system for use in a communications network, including at least one subscriber having a subscriber device, a service provider administrator, at least one third party application client and a third party application location service, the system comprising:
application program interfaces for interfacing said server with each of the at least one third party application client and with the third party application location service;
a database, comprising:
an identity record for each subscriber;
a preferences record for each subscriber; and
a presence record for each subscriber device, said presence record updated on a substantially real-time basis with the status of the subscriber within the communications network; and
a preference engine for processing a subscriber device location request from a third party application client by comparing the request with subscriber preferences stored in said database.

2. The system of claim 1 wherein, if the request from the third party application client is a request to send a message to a designated subscriber device, said preference engine further processes the request by:
accessing the subscriber device's presence record to determine whether the designated subscriber device is present;
accessing the subscriber's preferences record to determine if the designated subscriber device is available to the requesting third party application client; and
notifying the requesting third party application client of the designated subscriber device's availability status.

3. The system of claim 1, said database further comprising a location record for each subscriber device, said location record updated on a substantially real-time basis with the geographic location of the subscriber device within the communications network wherein, if the request from the third party application client is a request to send a message to a designated subscriber device if the designated subscriber device is within a predetermined geographic location, said preference engine further processes the request by:
accessing the subscriber's presence record to determine whether the subscriber is present;
accessing the subscriber's preferences record to determine if the subscriber device is available to the requesting third party application client;
accessing the subscriber's location record to determine if the subscriber device is within the predetermined geographic location; and
if the designated subscriber device is present and available and within the predetermined geographic location, providing such information to the requesting third party application client.

4. The system of claim 1, said database further comprising a device profile record for each subscriber device, said device profile record containing possible capabilities of each subscriber device.

5. The system of claim 4, further comprising means for allowing a subscriber to modify the device profile record by selecting capabilities to be enabled.

6. The system of claim 1, said database further comprising event registration records containing:
a list of events which trigger an event handler; and
a list of subscribers which participate in each event;
wherein, when a listed event is triggered by a listed subscriber, the event handler transmits a predetermined message to the listed subscriber.

7. The system of claim 1, wherein the APIs are PAM-compliant.

8. The system of claim 1, wherein the preference record for each subscriber includes information provided by each subscriber indicating what communications the subscriber desires to receive from third party application clients and select persons.

9. The system of claim 1, wherein the preference record for each subscriber further includes information provided by the subscriber indicating when the subscriber is willing to receive communications from third party application clients and select persons.

10. A method for managing subscriber presence, location and availability information across a communications network having: at least one subscriber with a subscriber device; a service provider administrator; at least one third party application client; and a third party application location service, the method comprising the steps of:
permitting a subscriber to log onto a server;
permitting the subscriber to enter a personal information profile into a server database;
permitting the subscriber to enter information pertaining to subscriber devices into the server database;
permitting the subscriber to establish availability preferences into the server database;
receiving from a third party application client an availability inquiry for a specified subscriber;
accessing the server database to determine if the specified subscriber is present;
further determining if the specified subscriber is available to the inquiring third party application; and
notifying the third party application of the presence and availability of the specified subscriber.

11. A presence, location and availability system for use in a communications network, including at least one subscriber having a subscriber device, a service provider administrator, at least one third party application client and a third party application location service, the system comprising:
application program interfaces for interfacing said server with each of the at least one third party application client and with the third party application location service;
a database, comprising:
an identity record for each subscriber;
a preferences record for each subscriber comprising information provided by each subscriber indicating what communications the subscriber desires to receive from third party application clients and select persons;
a device profile record for each subscriber device, said device profile record containing possible capabilities of each subscriber device;
a presence record for each subscriber device, said presence record updated on a substantially real-time basis with the status of the subscriber within the communications network; and
a location record for each subscriber device, said location record updated on a substantially real-time basis with the approximate geographic location of the subscriber device within the communications network; and
a preference engine for processing a subscriber device location request from a third party application client by comparing the request with subscriber preferences stored in said database.

12. The system of claim 11 wherein, if the request from the third party application client is a request to send a message to a designated subscriber device, said preference engine further processes the request by:
accessing the subscriber device's presence record to determine whether the designated subscriber device is present;
accessing the subscriber's preferences record to determine if the designated subscriber device is available to the requesting third party application client; and
notifying the requesting third party application client of the designated subscriber device's availability status.

13. The system of claim 11 wherein, if the request from the third party application client is a request to send a message to a designated subscriber device if the designated subscriber device is within a predetermined geographic location, said preference engine further processes the request by:
accessing the subscriber's presence record to determine whether the subscriber is present;
accessing the subscriber's preferences record to determine if the subscriber device is available to the requesting third party application client;
accessing the subscriber's location record to determine if the subscriber device is within the predetermined geographic location; and
if the designated subscriber device is present and available and within the predetermined geographic location, providing such information to the requesting third party application client.

14. The system of claim 1, said database further comprising event registration records containing:
a list of events which trigger an event handler; and
a list of subscribers which participate in each event;
wherein, when a listed event is triggered by a listed subscriber, the event handler transmits a predetermined message to the listed subscriber.
